(19) United States
(12) Patent Application Publication
(10) Pub. No.: US 2023/0251100 A1
(43) Pub. Date: Aug. 10, 2023

(54) DESTINATION RECOMMENDATION METHOD, ELECTRONIC APPARATUS, AND STORAGE MEDIUM

(71) Applicant: PATEO CONNECT+(Nanjing)Co., Ltd., Nanjing (CN)

(72) Inventor: Juan WANG, Wuhan (CN)

(21) Appl. No.: 17/969,217

(22) Filed: Oct. 19, 2022

(30) Foreign Application Priority Data
Feb. 9, 2022 (CN) 202210121386.6

(51) Int. Cl. G01C 21/34; G01C 21/36

(52) U.S. Cl. CPC G01C 21/3484; G01C 21/3617

(57) ABSTRACT

A destination recommendation method includes obtaining biometric identification information of a passenger in a vehicle and recommending a destination for the passenger according to the biometric identification information of the passenger and a correspondence between the passenger and the destination.

### CROSS-REFERENCE TO RELATED APPLICATION

This application claims priority to Chinese Patent Application No. 202210121386.6, filed on Feb. 9, 2022, the entire content of which is incorporated herein by reference.

### TECHNICAL FIELD

The present disclosure relates to the navigation technology field and, more particularly, to a destination recommendation method, an electronic apparatus, and a storage medium.

### BACKGROUND

When an autonomous vehicle is used, a user needs to trigger navigation proactively, and the vehicle will drive based on a travel route planned by a navigation device. When the navigation device plans the travel route, the user needs to specify a destination. That is, during each trip, the user needs to manually input the destination. Thus, an operation process is cumbersome, which affects travel efficiency.

### SUMMARY

Embodiments of the present disclosure provide a destination recommendation method. The method includes obtaining biometric identification information of a passenger in a vehicle and recommending a destination for the passenger according to the biometric identification information of the passenger and a correspondence between the passenger and the destination.

Embodiments of the present disclosure provide an electronic device, including a processor and a memory. The memory is communicatively coupled to the processor and stores an instruction that, when executed by the processor, causes the processor to obtain biometric identification information of a passenger in a vehicle and recommend a destination for the passenger according to the biometric identification information of the passenger and a correspondence between the passenger and the destination.

Embodiments of the present disclosure provide a non-transitory computer-readable storage medium. The non-transitory computer-readable storage medium stores a computer program that, when executed by a processor, causes the processor to obtain biometric identification information of a passenger in a vehicle and recommend a destination for the passenger according to the biometric identification information of the passenger and a correspondence between the passenger and the destination.

### BRIEF DESCRIPTION OF THE DRAWINGS

FIG. 1 is a schematic flowchart of a destination recommendation method according to some embodiments of the present disclosure.

FIG. 2 is a schematic flowchart of a method of storing correspondence between a passenger and a destination according to some embodiments of the present disclosure.

FIG. 3 is a schematic flowchart showing a sub-step of process S12 according to some embodiments of the present disclosure.

FIG. 4 is a schematic flowchart showing a destination recommendation method for a passenger using an electronic device according to some embodiments of the present disclosure.

FIG. 5 is a schematic diagram showing another destination recommendation method for a passenger using an electronic device according to some embodiments of the present disclosure.

FIG. 6 is a schematic structural diagram of an electronic device according to some embodiments of the present disclosure.

### DETAILED DESCRIPTION OF THE EMBODIMENTS

In order to better understand the present disclosure, various aspects of the present disclosure are described in more detail with reference to the accompanying drawings. These detailed descriptions are merely descriptions of exemplary embodiments of the present disclosure and are not intended to limit the scope of the present disclosure. Throughout this specification, the expression “and/or” includes any and all combinations of one or more of the associated listed items.

In this specification, the terms “first,” “second,” “third,” etc. are merely used to distinguish one feature from another feature area and do not represent any limitation on the feature, and especially do not represent any sequence. Therefore, without departing from the teachings of the present disclosure, a first in-vehicle image discussed in the present disclosure may also be referred to as a second in-vehicle image, and vice versa.

The terms such as “includes,” “included with,” “has,” “contains,” and/or “contained with” in this specification are open-ended rather than closed expressions, which indicate the presence of the features, elements, and/or components listed and do not exclude the presence of one or more other features, elements, components, and/or combinations thereof. In addition, when a term such as “at least one of” is after a listed feature, the expression decorates the whole feature not only an individual element listed. In addition, when embodiments of the present disclosure are described, “may” may be used to indicate “one or more embodiments of the present disclosure.” Further, the term “exemplary” is intended to refer to an example or illustration.

Unless otherwise specified, all terms (including engineering and scientific terms) used herein have the same meaning as commonly understood by those of ordinary skill in the art. Unless clearly specified in the present disclosure, words defined in a commonly used dictionary should be understood as having meanings consistent with their meanings in the context of the related technology, rather than being explained in an idealized or excessively formal manner.

When there is no conflict, embodiments in the present disclosure and the features of embodiments may be combined with each other. In addition, unless clearly defined or contradicted by the context, the specific steps included in the method of the present disclosure are not necessarily limited to the described order, but may be performed in any order or in parallel. The present disclosure will be described in detail below with reference to the accompanying drawings and in conjunction with embodiments of the present disclosure.

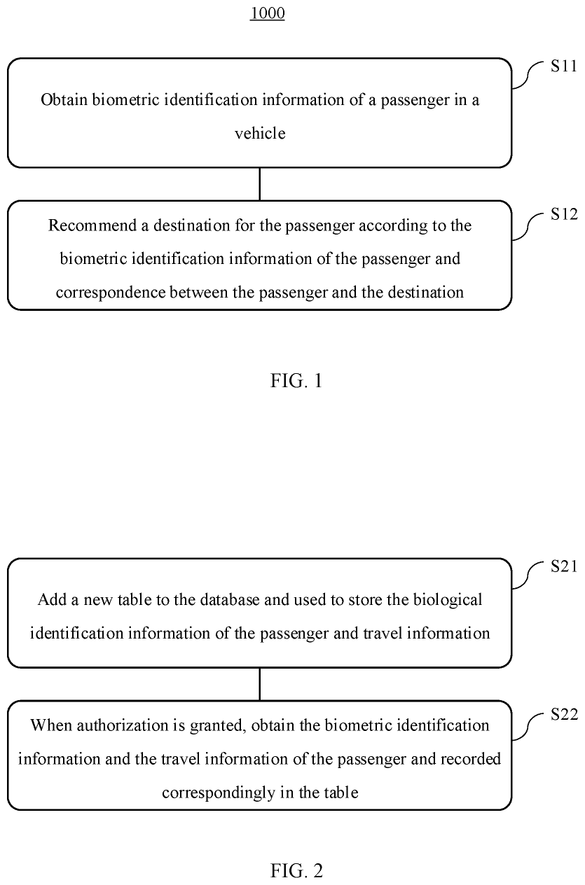

FIG. 1 is a schematic flowchart of a destination recommendation method 1000 according to some embodiments of the present disclosure. The destination recommendation method 1000 may be executed by an electronic device, such as a vehicle-mounted terminal, a server, etc. As shown in FIG. 1, the destination recommendation method 1000 of embodiments of the present disclosure includes obtaining biometric identification information of a passenger in a vehicle (S11) and recommending a destination for the passenger according to the biometric identification information of the passenger and correspondence between the passenger and the destination (S12).

In embodiments of the present disclosure, the electronic device may be configured to determine the identity of the passenger according to the biometric identification information that uniquely identifies the passenger and then recommend the destination for the passenger based on the correspondence between the passenger and the destination. In this manner, the user may not need to input the destination, which simplifies a user operation and improves travel efficiency.

In process S11, in some embodiments of the present disclosure, the biometric identification information may be determined according to any one or any combination of face image information, fingerprint information, and voiceprint information. The biometric identification information may further include, for example, other information that can uniquely identify the passenger, which is not limited by the present disclosure.

In some embodiment of the present disclosure, the destination recommendation method 1000 may further include, for example, before recommending the destination for the passenger according to the biometric identification information of the passenger and the correspondence between the passenger and the destination, obtaining the correspondence between the passenger and the destination.

In some embodiments of the present disclosure, obtaining the correspondence between the passenger and the destination may include, for example, in response to determining that the vehicle is started, obtaining a first in-vehicle image of the vehicle, in response to a speed of the vehicle being less than a predetermined speed value, obtaining a second in-vehicle image of the vehicle, determining the passenger who gets off the vehicle according to the first in-vehicle image and the second in-vehicle image, determining the destination of the passenger who gets off the vehicle according to current location information, and recording the biometric identification information of the passenger and the destination of the passenger who gets off the vehicle to update the correspondence between the passenger and the destination. That is, by comparing an in-vehicle image taken when the vehicle is started and an in-vehicle image taken each time when the vehicle stops, whether someone gets off the vehicle may be determined. If someone gets off the vehicle, the current position information of the vehicle may be used as the destination of the passenger who gets off the vehicle. The correspondence between the passenger and the destination of the passenger may be updated. In some embodiments, in a process of using the vehicle, by updating the correspondence between the passenger and the destination in time, a recommendation basis with a better real-time performance may be provided for a destination recommendation process. Thus, the destination may be recommended for the passenger more accurately.

In some embodiments, the electronic device may not only record the two pieces of information of the biometric identification information and the destination of the passenger but also record travel time attribute information of the passenger. In some embodiments, in response to determining that the vehicle is started, the electronic device may obtain boarding time of the passenger in the first in-vehicle image and determine the travel time attribute information of the destination of the passenger who gets off the vehicle according to the boarding time of the passenger. Recording the biometric identification information of the passenger who gets off the vehicle and the destination of the passenger who gets off the vehicle to obtain the correspondence between the passenger who gets off the vehicle and the destination may include recording the biometric identification information of the passenger who gets off the vehicle, the destination of the passenger who gets off the vehicle, and the travel time attribute information of the destination of the passenger who gets off the bus, to update the correspondence among the passenger, the destination, and the travel time attribute information.

In some embodiments, according to the boarding time of the passenger, the electronic device may be configured to determine the travel time attribute information of the destination of the passenger who gets off the vehicle. For example, for the destination of the passenger who gets off the vehicle, the travel time of the destination of the passenger who gets off the vehicle may be obtained according to the boarding time corresponding to the passenger. According to the travel time of the destination of the passenger who gets off the vehicle, the travel time attribute information of the destination of the passenger who gets off the vehicle may be determined.

In some embodiments, the electronic device may be configured to obtain travel times of destinations of passengers who get off the vehicle using a K-means clustering algorithm according to boarding times of all passengers corresponding to the electronic device. In some embodiments, the boarding times may be used as to-be-processed objects. A set of time data with a most dense distribution may be calculated by the k-means clustering algorithm. A calculation logic may be as follows.

A number K objects may be randomly selected as initial clustering centers. K may be adjusted according to a number of samples that are to be analyzed and needs of a project. A distance between each boarding time and each initial clustering center may be calculated. Each boarding time may be assigned to a clustering center closest to the boarding time. The clustering center and objects assigned to the clustering center may represent a cluster. When all objects are assigned, the clustering center of each cluster may be re-assigned. Then, the distance between each boarding time and each clustering center may be re-calculated. The calculation may be terminated until any one of the following conditions is satisfied.

Condition 1, no object is re-assigned to different clusters.

Condition 2, no (or a minimum number of) clustering center changes again.

Condition 3, a sum of squared errors is locally minimal.

The electronic device may be configured to count most densely distributed data according to the above method and determine the travel time of the destination of the passenger who gets off the vehicle based on the most densely distributed data.

In some embodiments, the correspondence between the passenger and the destination or the correspondence among the passenger, the destination, and the travel time attribute information may be stored in a database in a table format. The database may include, for example, a cloud database or a database of the electronic device, which is not limited here.

In a process of recording the above-mentioned correspondence, other information such as a boarding location may also be recorded, which is not limited by the present disclosure.

By taking the passenger face image information (also referred to as user portrait) as the biometric identification information of the passenger, and the above correspondence may be stored in the cloud database as an example. As shown in FIG. 2, the process of storing the above correspondence may include, for example, processes S21 and S22.

At S21, a new table (i.e., Table 1) is added to the database and used to store the biological identification information of the passenger and travel information. The travel information may include, for example, information such as the destination, the travel time attribute information, etc.

TABLE 1

| | | | | | Getting- | Getting- | | | |
|---|---|---|---|---|---|---|---|---|---|
| | Image | Image | Boarding | Boarding | off | off | Deletion | Reserved | Reserved |
| SID | ID | URL | time | location | time | location | flag | segment 1 | segment n |
| [symbol] | [symbol] | [symbol] | [symbol] | [symbol] | [symbol] | [symbol] | [symbol] | [symbol] | [symbol] |

[symbol]

indicates data missing or illegible when filed

In some embodiments, as shown above, a table name of Table 1 may be set to ImageSchedule. For example, a primary key of the table may be a security identifier (SID) of the electronic device. The primary key may be a unique identifier, which identifies different security identifiers and is a unique label of the electronic device. The primary key may be used to distinguish related information of different electronic devices. In Table 1, a passenger ID (ImageID) and a face image of the passenger (ImageURL) may be set to distinguish the passenger. The boarding time, the boarding location, the getting-off time, and the getting-off location may be used to record the travel information of the user. The deletion flag may be used to indicate whether to delete a row of a travel record during a table updating process next time. A number of reserved segments may be set according to an actual project to reserve an available segment for the travel record. In Table 1, value types of SID and ImageID may include, for example, BIGINT of an integer data type. Value types of ImageURL, boarding location, getting-off location, reserved segment 1, . . . , and reserved segment n may include, for example, a variable-length string (VARCHAR). Value types of the boarding time and getting-off time may be set to, for example, time format type (DATETIME). Value types of the deletion flag may include, for example, SMALLINT of the integer data type.

Table 1 is only an example. Without departing from the teaching of the present disclosure, the table name may be set as needed, and segments that are to be recorded may be selectively increased or decreased, which is not limited by the present disclosure.

Without departing from the teaching of the present disclosure, the data type of the segments in the table may be set as needed, which is not limited by the present disclosure.

At S22, when authorization is granted, the biometric identification information and the travel information of the passenger are obtained and recorded correspondingly in the table (i.e., Table 1).

In some embodiments, after the user is boarded and performs the ignition, a built-in camera in the vehicle may be turned on and capture the first in-vehicle image, which is used to capture a face image. After the camera captures and processes the face image, the face image may be saved in an image format such as JPG and uploaded to a local cache as a face data source. The electronic device may be configured to request Table 1 of the cloud database and compare whether same face data exists. If the same face data exists, a corresponding ImageID in Table 1 may be saved in the database with the current face image and the capture time of the face image (i.e., boarding time). If the same face data does not exist, a new ImageID may be generated and stored in the database with the current face image and the capture time of the face image (i.e., boarding time). In some embodiments, location information of the vehicle can be obtained as the boarding location and stored in the database. Other segments in Table 1 may be left blank temporarily.

For example, user 1 may board on the vehicle at XX Square in Wuhan at 14:54 on Sep. 13, 2021. Some data in Table 1 are shown as follows.

| | | | Boarding | Boarding |
|---|---|---|---|---|
| SID | ImageID | ImageURL | time | location |
| 1 | 00000001 | http://files . . . .jpg | 2021-09-13 | XX Square |
| | | | 14:54:00 | in Wuhan |

After the electronic device determines that the vehicle arrives at the destination, the built-in camera in the vehicle starts a shooting function. That is, the second in-vehicle image may be obtained. The electronic device may be configured to compare the face images in the second in-vehicle image with the face images in the first in-vehicle image captured during the ignition one by one. Then, the getting-off time and getting-off location in Table 1 may be updated.

Through the above method, the getting-off time and getting-off location of each passenger may be updated in Table 1 until all the passengers get off. In this process, information about all passengers may be recorded.

In some embodiments, a manner of determining that the vehicle arrives at the destination may include, for example, determining whether a speed of the vehicle is smaller than a predetermined speed. If the speed is smaller than the predetermined speed, the vehicle may stop. Based on a comparison between the face image currently captured and the face image captured when the ignition is performed, whether the passenger changes may be determined. If the passenger changes, the vehicle stop location may be used as the getting-off location.

In some embodiments, in order to facilitate determining travel rules when a plurality of passengers ride together, the information of the plurality of persons may be extracted and recorded in a new table (e.g., Table 2). For example, ImageID in Table 1 may be formed by combining the ImageIDs of the passengers. In order to record the getting-off locations of the passengers, a plurality of getting-off locations may be set, that is, getting-off location 1, getting-off location 2, . . . , and getting-off location n. n may be a maximum passenger capacity of the vehicle. In a data recording process, the ImageID segments of the passengers in Table 1 may be periodically polled. Recent (such as nearly half a year) data may be analyzed. If two or more sets of data having the getting-off locations that are exactly matched exist, the data may be stored in Table 2. A table name of Table 2 may be, for example, RecommendRole1. The structure of Table 2 may be as follows.

TABLE 2

| | | | | | | Most | Reserved | Reserved | |
|---|---|---|---|---|---|---|---|---|---|
| | Image | Destination | Destination | | Number | recent co- | segment | segment | |
| SID | ID | 1 | 2 | . . . | of trips | travel time | 1 | n | Status |
| [symbol] | [symbol] | [symbol] | [symbol] | [symbol] | [symbol] | [symbol] | [symbol] | [symbol] | [symbol] |

[symbol]

indicates data missing or illegible when filed

The meaning and value type of the SID may be the same as the meaning and value type of the SID in Table 1, and ImageID may be formed by combining ImageIDs of the passengers. The value type of destination 1, destination 2, . . . , may be the same as the value type of the getting-off location in Table 1. The value type of the number of trips may be set as an integer data type. The value type of the most recent co-travel time may be, for example, a time format type. The value type of reserved segment 1, reserved segment n, and status may be, for example, VARCHAR. When the same ImageID has different destination combinations, data may be written into Table 2 in reverse order of the number of trips. When the numbers of trips to different destinations are also the same, data may be written according to the latest co-travel time. Each time when data is written into the table, all previous data may be set to a non-writable status. For example, all the previous data may be set to 1 (Status=1). All the data written at the current time may be set to the writable status. For example, all the data written at the current time may be set to 0 (Status=0). When the destination is recommended for the passenger, the data with Status=1 may be selected in the table for analysis.

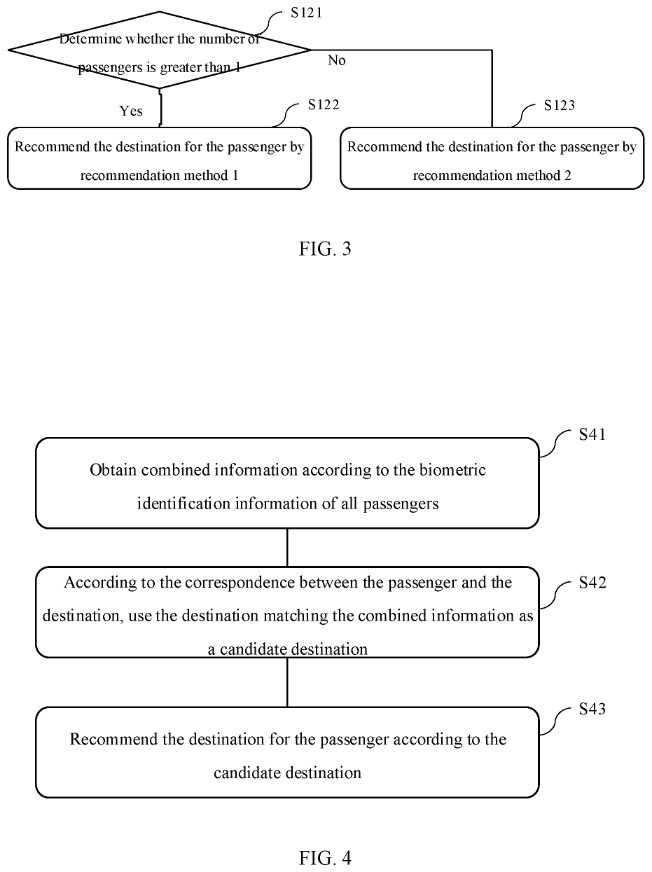

In process S12, in some embodiments of the present disclosure, for a single-passenger travel and a multi-passenger travel, destinations may be recommended in different manners. In some embodiments, as shown in FIG. 3, according to the biometric identification information of the passenger and the correspondence between the passenger and the destination, the destination recommendation method for the passenger by the electronic device may include the following processes.

At S121, whether the number of passengers is greater than 1 is determined. In response to the number of passengers being greater than one, process S122 is performed. In response to the number of passengers being equal to one, process S123 is performed.

At S122, the destination is recommended for the passenger by recommendation method 1. Then, process S12 is proceeded to finish.

At S123, the destination is recommended for the passenger by recommendation method 2. Then, process S12 is proceeded to finish. Recommendation method 1 and recommendation method 2 are different.

In some embodiments, the destination may be recommended for different numbers of passengers in different recommendation methods. Thus, the destination may be recommended for the passengers more flexibly. Recommended method 1 and recommended method 2 may be set as needed.

In some other embodiments of the present disclosure, the electronic device may be configured to recommend the destination for the single-passenger travel and multiple-passenger travel in a same recommendation method. The recommendation method may be, for example, recommendation method 2 above. That is, the electronic device may not be configured to determine the number of passengers and may be configured to recommend the destination for the passengers in recommendation method 2.

Recommendation method 1 and recommendation method 2 above are described below in examples.

In recommendation method 1 of embodiments of the present disclosure, as shown in FIG. 4, the destination recommendation method for the passenger by the electronic device includes, for example, processes S41 to S43.

At S41, combined information is obtained according to the biometric identification information of all passengers.

In some embodiments, the electronic device may be configured to obtain the numbering information of all the passengers according to the biometric identification information of all the passengers and the correspondence between the biometric identification information and the numbering information of the passengers and combine the numbering information of all the passengers to obtain the combined information. Numbering may be performed for the passengers. The combined information may be created based on the numbering of the passengers, which can reduce a data volume.

Without departing from the teachings of the present disclosure, the combined information may be obtained based on the biometric identification information of the plurality of passengers by directly combining the biometric identification information, which is not limited by the present disclosure.

In some embodiments, the numbering information of all the passengers may be combined, for example, in age order of the passengers to combine the numbering information of all the passengers in sequence to obtain the combined information. The numbering information of the passengers may be combined together in sequence based on the ages of the passengers. Thus, different combined information corresponding to the same passenger obtained due to different combination sequences may be avoided, which reduces matching failure.

Without departing from the teachings of the present disclosure, the numbering information of all the passengers may also be combined together in sequence according to other parameters of the passengers, which is not limited in the present disclosure.

At S42, according to the correspondence between the passenger and the destination, the destination matching the combined information is used as a candidate destination.

In some embodiments, the correspondence between the passengers and the destination may include the correspondence between the combined information of the plurality of passengers and the destination. Based on the correspondence, the electronic device may be configured to search for the destination corresponding to the combined information as the candidate destination for the current trip of all the passengers.

In some embodiments, if the electronic device determines that no destination matching the combined information exists, that is, no driving record matching the combined information exists, a subsequent destination recommendation mechanism may not be triggered. In some embodiments, the electronic device may be configured to remind the passenger to self-input the destination, which is not limited here.

At S43, the destination is recommended for the passenger according to the candidate destination.

In some embodiments, the electronic device may be configured to recommend all candidate destinations to the passenger or select some candidate destinations to recommend to the passenger based on some predetermined processing logic, which is not limited by the present disclosure.

The method for recommending the destination when the plurality of persons travel together may be described in examples by taking the face image information of the passenger as the biometric identification information of the passenger below.

The electronic device may be configured to capture face image information of all the passengers in the vehicle when the vehicle is started. When ImageID that is obtained based on the combination of the face image information currently captured matches ImageID in Table 2, the recommendation mechanism may be triggered, otherwise the recommendation mechanism may not be triggered. When the recommendation mechanism is triggered, that is, after the driving records matching combined ImageID are determined to exist in Table 2, the candidate destinations may be determined based on the driving records. The destination may be recommended for the passengers according to the candidate destinations. If the driving records in Table 2 are arranged in descending order of the number of trips, the electronic device may recommend the destination in order from top to bottom in Table 2. A number of times to recommend a destination may be set as needed, for example, three times to recommend a destination. After the number of times to recommend a destination is reached, if the passenger still does not confirm the recommended destination, the recommendation may be ended.

In some embodiments, the destination recommendation method by the electronic device may include, for example, feeding back all the driving records to the passengers in the following format according to a storage order in Table 2.

First set of data: {Destination 1, Destination 2 (optional), . . . , Destination 5 (optional)}.

Second set of data: {Destination 1, Destination 2 (optional), . . . , Destination 5 (optional)}.

Third set of data: {Destination 1, Destination 2 (optional), . . . , Destination 5 (optional)}.

The second and third sets of data are optional. If related records exist in Table 2, the related records may be fed back to the passengers in the above format, otherwise, only the first set of data may be fed back. Destination 2 to Destination 5 are optional. If related records exist in Table 2, the related records may be fed back to the passengers in the above format, otherwise, only Destination 1 may be fed back.

Without departing from the teachings of the present disclosure, the above three sets of data may be recommended to the passengers at the same time or may be recommended to the passengers in sequence according to an order of the three sets of data in Table 2, which is not limited by the present disclosure.

For example, the method of feeding back the above data by the electronic device may include, for example, transmitting the above data to a navigation system of the vehicle and recommending a to-be-recommended destination determined to the passenger by the navigation system in a manner, such as voice according to the received parameter. For example, according to the received parameter, the navigation system may provide the voice of “The system matches a multi-passenger travel scenario for you, do you want to navigate to Destination 1, Destination 2, . . . , Destination 5 in sequence, please confirm?.” The navigation system may navigate to Destination 1, Destination 2, . . . , Destination 5 according to a voice command of the passenger, for example, the passenger may answer “Yes,” “Yeah,” or other confirmation keywords. If the passenger answers with a negative voice such as “No” and “Nein,” the navigation system may be configured to check whether the second set of data is available to recommend to the passenger. If the second set of data is available, the navigation system may continue to recommend. The recommendation logic may be the same as the first time. If a third recommendation is completed, the passenger is still dissatisfied with the recommended destination. The current recommendation may be ended, and the current driving record may be recorded in Table 1 as a subsequent data source.

In some embodiments, in the current recommendation process, when the navigation system receives the destination input by the passenger through a manner, such as voice, the recommendation may be terminated. The navigation system may navigate for the passenger according to the destination given by the passenger.

In the destination recommendation method of some embodiments of the present disclosure, the destination may be recommended to the passengers based on travel habits of the plurality of passengers. The plurality of passengers may not need to enter destinations, respectively. Thus, the destination recommendation process may be more intelligent, which simplifies the operation process to improve the travel efficiency.

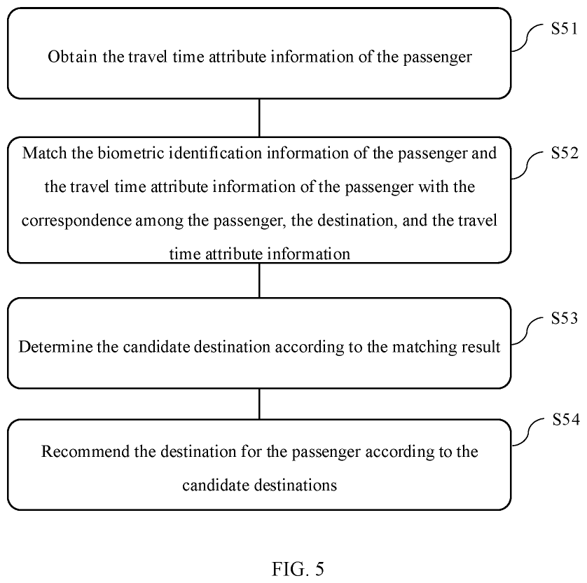

In recommended method 2 of embodiments of the present disclosure, as shown in FIG. 5, the destination recommendation method for the passenger by the electronic device includes, for example, processes S51 to S54.

At S51, the travel time attribute information of the passenger is obtained.

In some embodiments, the electronic device may be configured to obtain the boarding time of the passenger and determine the travel time attribute information of the passenger according to the boarding time of the passenger. The travel time attribute information may include but not be limited to, for example, any one or more pieces of the following information

Weekend or weekday information may be obtained based on an analysis of date information of the boarding time.

Information such as on-duty time, off-duty time, and lunch break time is obtained based on an analysis of time information of the boarding time.

For example, a certain boarding time may be 11:59:54 on Nov. 26, 2021. The travel time attribute information based on the boarding time may include, for example, weekday and/or lunch break time.

Without departing from the teachings of the present disclosure, other information may also be searched based on the boarding time as the travel time attribute information, which is not limited by the present disclosure.

For example, in order to facilitate the destination recommendation based on the travel time attribute information, a new table (i.e., Table 3) may be added to the database to record relevant information. For example, Table 1 in the database may be periodically polled. In each poll, entire Table 1 may be searched, and data generated between a current time node and a last time node may also be searched. Vehicle using information may be displayed in groups according to the passengers and different getting-off locations. After same ImageID is grouped with the same getting-off location, the corresponding boarding time may be analyzed to extract year/month/day of the time for analysis. The time attribute of the date may be checked in sequence, for example, whether the time attribute of the date is weekday or weekend, or whether a regular interval exists between dates. If a certain rule is extracted, this piece of information may be stored as a piece of attribute information in Table 3 of the cloud database. The table name of Table 3 may be set to RecommendRole2. If the extracted data cannot be described by the rule, such as weekday, weekend, or a same time interval, the vehicle using rule may not be recorded. The rule extracted in the current step may be stored in a segment of the vehicle using rule in Table 3. A structure of Table 3 may be set as follows.

TABLE 3

| | | | | Board- | Board- | Vehicle |
|---|---|---|---|---|---|---|
| | | | Desti- | ing start | ing end | using |
| SID | ImageID | ImageURL | nation | time | time | rule |
| [symbol] | [symbol] | [symbol] | [symbol] | [symbol] | [symbol] | [symbol] |

[symbol]

indicates data missing or illegible when filed

The boarding time segment of the same getting-off location for the same ImageID may be analyzed. The boarding time may be analyzed by the clustering algorithm and fill an analysis result in Table 3.

In some embodiments, the boarding times may be used as to-be-processed objects. A set of time data that is most densely distributed may be calculated by the k-means clustering algorithm. The calculation logic may be as follows.

K objects may be randomly selected as initial cluster centers. K may be adjusted according to the number of samples to be analyzed and the needs of the project. A distance between each boarding time and each initial cluster center may be calculated. Each boarding time may be assigned to the cluster center closest to the boarding time. The cluster centers and the objects assigned to the cluster centers may represent a cluster. When all the objects are assigned, the cluster centers of each cluster may be re-assigned, and then re-calculation may be performed. The operation may be terminated until any of the following conditions is satisfied.

Condition 1, no object is reassigned to a different cluster.

Condition 2, no (or minimum number) cluster center changes again.

Condition 3, a sum of squared errors is locally minimized.

The data that is most densely distributed may be counted according to the above method. The earliest boarding time of time points in the densest data may be written in the boarding start time segment of Table 3. The latest boarding time of time points in the densest data may be written in the boarding end time segment of Table 3. Thus, the vehicle using rule obtained based on Table 1 may be combined with Table 3 to facilitate the electronic device to recommend the destination based on the vehicle using rule to fix the vehicle using habits of the passenger on a weekday and rest day.

At S52, the biometric identification information of the passenger and the travel time attribute information of the passenger are matched with the correspondence among the passenger, the destination, and the travel time attribute information.

For example, the electronic device may first be configured to use the driving record with the ImageID in Table 3 the same as the passenger ImageID as the driving record for matching based on the biological identification information (ImageID) of the passenger. The electronic device may be further configured to determine whether a driving record with the time attribute information matched with the travel time attribute information of the passenger exists in the driving records for matching. If the driving record with the time attribute information matched with the travel time attribute information of the passenger exists, a matching result may indicate that the matching is successful. The matching result may be determined according to the matched driving record, for example, the driving record may be used as a matching result, or the destination of the driving record may be used as the matching result. Otherwise, no matched driving record may exist, and the matching result may indicate that the matching fails.

For another example, the database may also store the above information of the boarding start time and the boarding end time. The electronic device may be further configured to perform a destination recommendation in connection with the boarding time of the passenger to improve the accuracy of the recommendation.

For example, the electronic device may be configured to determine whether the boarding time of the current time of using the vehicle is between the boarding start time and the boarding end time of a certain driving record in Table 3. After the boarding time is determined to be between the boarding start time and the boarding end time of the certain driving record, whether the travel time attribute information of the driving record matches the travel time attribute information may be determined. If the travel time attribute information of the driving record matches the travel time attribute information, the matching result may indicate that the matching is successful. The matching result may be determined according to the matching driving record. For example, the driving record may be used as the matching result, or the destination of the driving record may be used as the matching result. Otherwise, the matching driving record may not exist, and the matching result may indicate that the matching fails.

For another example, the electronic device may be further configured to first determine whether a driving record having the travel time attribute information in Table 3 matched with the travel time attribute information exists. If the matched driving record is determined to exist, whether the boarding time of the current vehicle use is between the boarding start time and the boarding end time of the driving record. If the boarding time of the current vehicle use is between the boarding start time and the boarding end time of the driving record, the matching result may indicate that the matching is successful. The matching result may be determined according to the matching driving record. For example, the driving record may be used as the matching result, and the destination of the driving record may be used as the matching result. If no driving record having the travel time attribute information matching the travel time attribute information is determined, or the boarding time of the current vehicle use is not between the boarding start time and boarding end time of the driving record, no matching driving record may exist, and the matching result may indicate that the matching fails.

Without departing from the teachings of the present disclosure, the matching may be performed through other parameters, which is not limited by the present disclosure.

At S53, the candidate destination is determined according to the matching result.

In some embodiments, the matching result may include the destination of the matched driving record. The destination of the driving record may be used as the candidate destination.

In some embodiments, considering a situation where the matching fails, the electronic device may perform the destination recommendation based on other information in Table 1, Table 2, or Table 3. In some embodiments, the electronic device may be configured to obtain a boarding location of the passenger and determine the candidate destination according to the boarding location of the passenger and the correspondence between the boarding location and the destination when the matching result in process S53 indicates that the matching fails. For example, if the matching fails based on the travel time attribute information of the passenger and the biometric identification information of the passenger, the biometric identification information of the passenger and the boarding location of the passenger may be matched with ImageID and the boarding location in Table 1. If a driving record with the matched ImageID and the boarding location exists, the getting-off location corresponding to the driving record may be used as the candidate destination. Thus, probability of successfully determining the to-be-recommended destination may be increased.

Without departing from the teachings of the present disclosure, the candidate destination may further be matched according to other information, which is not limited by the present disclosure.

The method for recommending a destination when the matching result in process S53 indicates that the matching fails may be described with examples below by taking the face image information of the passenger as the biometric identification information of the passenger.

In some embodiments, after the matching result in process S53 indicates that the matching fails, the electronic device may perform the destination recommendation according to the boarding location of the passenger. The number of recommendation times may be set to one or more as needed. In some embodiments, according to the face image information and the boarding location, the electronic device may search all or recent (e.g., nearly half a year) driving records in Table 1 to obtain the candidate destination. In some embodiments, the driving records obtained by the search may be stored in Table 3. A recommendation priority of the driving records searched in the process may be set to a second level. That is, the recommendation priority of the destination determined based on the face image information (ImageID) and travel time attribute information may be set to a first level, and the recommendation priority of the destination determined based on the face image information (ImageID) and the boarding location may be the second level. When the driving record with the recommendation priority of the first level corresponding to ImageID of the passenger does not exist, the driving record with the recommendation priority of the second level may be further searched.

When the vehicle is started, a vehicle location may be uploaded to the electronic device as the boarding location of the passenger. Whether a driving record with the boarding location in Table 3 is the same as the boarding location of the passenger exists may be determined. If the driving record exists, the destination in the driving record may be used as the candidate destination to further perform the intelligent destination recommendation subsequently.

In some embodiments, if a plurality of driving records with the boarding locations the same as the boarding locations of the passenger exist, the destinations of the driving records may be fed back to the passenger in reverse order according to the getting-off time recorded in the driving records. For example, the destinations may be fed back to the passengers in the following format.

Destination 1, Destination 2 (optional), Destination 3 (optional), . . . , Destination 6 (optional).

The method in which the electronic device feeds back the above-mentioned data may include, for example, transmitting the above data to the navigation system of the vehicle and providing the data to the passenger through a manner, such as voice, by the navigation system according to the received parameters. For example, after the navigation system receives the above-mentioned data, the navigation system may start to provide the destination. When no matched driving record exists, a number of determined destinations to be recommended may be 0. Thus, the destination recommendation may not be started. When only one driving record is matched, only one determined destination that is to be recommended may exist. The determined destination that is to be recommended may be recommended. The destination recommendation may be performed. When a plurality of driving records are matched, that is, a plurality of determined destinations that are to be recommended may exist, one time recommendation may be performed. A first T destinations of the plurality of determined destinations that are to be recommended may be recommended. T may be, for example, a positive integer such as 1 or 2. For example, T=2, the navigation system may provide “The system matches you with the destinations {destination to be recommended 1} and {destination to be recommended 2}, whether to go, please say the address you want to go to?” through voice. According to the voice command of the passenger, if the voice command of the passenger includes to-be-recommended destination 1 or to-be-recommended destination 2 as the destination, the navigation system may direct navigate to the destination. If the destination included in the voice command of the passenger is not to-be-recommended destination 1 or to-be-recommended destination 2, and another address is provided, the navigation function may be started to navigate to the destination said by the user. If the destination included in the voice command of the passenger is not to-be-recommended destination 1 or to-be-recommended destination 2, and no other address is provided, a second recommendation may be started, for example, to-be-recommended destination 3 and to-be-recommended destination 4 may be recommended. The process of processing a response mode of the passenger by the navigation system may be the same as the processing process in the first recommendation, which is not repeated here. If the determined destinations that are to be recommended are recommended, and the passenger still does not satisfy the destination, the recommendation may be ended, and the electronic device may remind the passenger to self-enter the destination.

At S54, the destination is recommended for the passenger according to the candidate destinations.

In some embodiments, by recommending the destination for the passenger based on the travel time attribute information, the travel habits of the passenger may be better analyzed at different times, and the destination may be more accurately recommended for the passenger.

For the sake of clarity, in embodiments of the present disclosure, the process of obtaining the travel time attribute information of the passenger may be used as a sub-process of recommending the destination for the passenger. Without departing from the teachings of the present disclosure, the travel time attribute information of the passenger may be obtained while the biometric identification information of the passenger is obtained in the vehicle. The process may be performed in another process, which is not limited by the present disclosure.

The destination recommendation method may be described by taking the face image information of the passenger as the biometric identification information of the passenger for example.

After the vehicle is started, the electronic device may determine ImageID according to the face image information of the passenger. According to the vehicle start time (i.e., boarding time), the electronic device may be configured to determine the travel time attribute information of the passenger. The electronic device may search in Table 3 of the database according to the ImageID and the boarding time to determine whether the boarding time is between the boarding start time and boarding end time of any driving record in Table 3. If the boarding time is between the boarding start time and the boarding end time of a driving record, the travel time attribute information of the passenger may be compared with the vehicle using rule segment of Table 3. For example, if the vehicle using rule segment=weekday, the electronic device may determine whether the travel time attribute information of the passenger is a weekday. If the travel time attribute information of the passenger matches the vehicle using rule segment, the destination may be recommended based on the driving record. The electronic device may be configured to send the determined destination to the navigation system of the vehicle. The navigation system of the vehicle may feedback the destination to the passenger through a voice broadcast of “The system matches your frequent destination during this time period for you, do you want to go to {destination to be recommended}?” The passenger may feed a choice of the passenger back to the navigation system through voice or a gesture. When the passenger answers the consent keywords such as “Yes” and “Yeah” by voice or makes the “OK” gesture, the navigation system may use the to-be-recommended destination as the destination for navigation and inform the passenger by voice “The vehicle is about to start, this trip is expected to take xx minutes. Please fasten your seat belt.” In some embodiments, when the destination is about to arrive, for example, 2 minutes may be left to arrive at the destination (the time is adjustable), the navigation system may broadcast again through the voice “There are x minutes to the destination, please take your belongings and get ready to get off.” When the passenger answers the consent keywords such as “No” and “Nein” by voice, makes a gesture such as “wave hand”, or receives other navigation information, the destination recommended this time may be determined to not satisfy the requirement of the passenger. The vehicle may go to the destination according to the navigation set by the passenger. For example, the passenger may choose the voice to inform the destination, the navigation system may display the navigation result on a screen of the vehicle terminal according to the destination provided by the voice of the passenger. The navigation system may ask the passenger to confirm by voice. After the passenger confirms the destination, the navigation system may navigate the vehicle to the destination.

If the travel time attribute information of the passenger and the vehicle using rule segment do not match, the electronic device may perform the destination recommendation or remind the passenger to enter the destination in another manner. For example, when the travel time attribute information of the passenger and the vehicle using rule segment do not match, the candidate destination may be determined according to the boarding location of the passenger. For the specific process of determining the candidate destination according to the boarding location of the passenger, reference may be made to the above-related description, which is not repeated here.

The destination recommendation method for the passenger according to the candidate destinations mentioned in recommendation method 1 and recommendation method 2 may be described below with examples.

In recommendation method 1 of embodiments of the present disclosure, recommending the destination for the passenger by the electronic device according to the candidate destinations may include, for example, in response to the number of candidate destinations being greater than the predetermined number, selecting the predetermined number of candidate destinations as the candidate destinations according to travel information of the candidate destinations, and recommending the to-be-recommended destinations. For example, the predetermined number may be one or more, which is not limited by the present disclosure.

For example, the travel information may include, for example, a number of trips and/or travel time. That is, when the determined candidate destinations are more than the predetermined number, a candidate destination with a greater number of trips or a travel time closer to the current time may be selected as the destination to be recommended. Thus, the recommended destination may better conform to the recent vehicle using habits of the passenger.

In some embodiments, the travel information may include the number of trips. The electronic device may be configured to sort the candidate destinations according to the number of trips to the candidate destinations to obtain a sorting result. After the sorting result is obtained, the electronic device may select the predetermined number of candidate destinations according to the sorting result based on the number of trips to the candidate destinations. The number of trips to the selected candidate destinations may be greater than or equal to the number of trips to unselected destinations. The selected candidate destinations may be used as the to-be-recommended destinations. For example, according to the above description related to Table 2, when the electronic device forms the table for storing the driving records as shown in Table 2, the electronic device may write the driving records into the table in the order of the numbers of trips from most to least. When the to-be-recommended destination is selected, the destinations corresponding to the predetermined number of driving records that are arranged in front of the table may be selected as the to-be-recommended destinations.

In some embodiments, the travel information may further include the travel time. During the process of sorting the candidate destinations by the electronic device according to the number of trips of the candidate destinations, the electronic device may perform sorting on the plurality of candidate destinations according to the travel time of the plurality of candidate destinations to obtain the sorting result in response to the numbers of trips of the plurality of candidate destinations being the same. In some embodiments, the travel time may be, for example, the most recent co-travel time in Table 2. That is, when the numbers of the trips of the plurality of driving records are the same, the driving records may be written into the table in an order of the travel time of the driving records from the nearest to the farthest.

In some embodiments, in response to the number of to-be-recommended destinations being greater than 1, the electronic device may sequentially recommend the to-be-recommended destinations according to the sorting result.

In some embodiments, after the electronic device recommends all the to-be-recommended destinations, the electronic device may still not receive voice information. Then, the electronic device may remind the passenger to select a recommended destination. That is, the passenger may not be satisfied with the recommended destination, and the electronic device may remind the passenger to self-enter the destination.

In recommendation manner 2 of embodiments of the present disclosure, the electronic device may obtain the boarding time of the passenger. The destination recommendation method for the passenger according to the candidate destinations may include, for example, in response to the number of candidate destinations being greater than the predetermined number, selecting the predetermined number of candidate destinations as the to-be-recommended destinations according to the travel time corresponding to the candidate destinations and the boarding time of the passenger, and recommending the to-be-recommended destinations.

In some embodiments, the electronic device may perform sorting on the candidate destinations according to the travel time of the candidate destinations (i.e., the travel time in the driving record corresponding to the candidate destinations), a time difference between the travel time and the boarding time of the passenger, and according to an order of the time differences from small to large.

Without departing from the teachings of the present disclosure, the to-be-recommended destinations may be selected from the candidate destinations based on other parameters, which are not repeated by the present disclosure.

The process division of the above methods are merely for the purpose of clear description, and the processes may be combined into one process or some process may be divided into a plurality of processes, as long as the same logical relationship is included, the processes are within the scope of the present disclosure. Unnecessary modifications in the algorithm may be added, or an unnecessary design may be introduced. The key design that does not change the algorithm and the process may be in the scope of the present disclosure.

Embodiments of the present disclosure also provide an electronic device. The electronic device may include at least one processor and a memory communicatively connected to the at least one processor. The memory may store an instruction that may be executed by the at least one processor. The instruction may be executed by the at least one processor. Thus, the at least one processor may execute the above destination recommendation method.

Embodiments of the present disclosure also provide a computer-readable storage medium. The storage medium may store a computer program. When the computer program is executed by the processor, the destination recommendation method may be implemented.

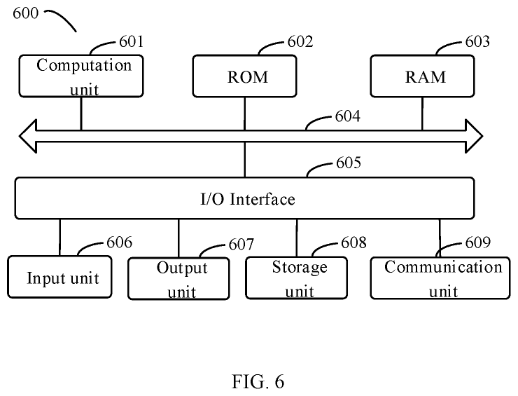

FIG. 6 is a schematic structural diagram of an electronic device 600 according to some embodiments of the present disclosure. The electronic device 600 may be intended to represent various forms of a digital computer, such as a laptop, a desktop, a workstation, a personal digital assistant, a server, a blade server, a mainframe computer, and another suitable computer. The electronic device may also represent various forms of mobile devices, such as a personal digital processor, a cellular phone, a smartphone, a wearable device, and another similar computation device. Components shown in the specification, connections and relationships of the components, and functions of the components may be merely used as examples, and are not intended to limit the description of the specification and/or the implementations of the present disclosure claimed in the specification.

As shown in FIG. 6, the electronic device 600 includes a computation unit 601. The computation unit 601 may be configured to perform suitable actions or processing according to the computer program stored in the read-only memory (ROM) 602 or the computer program loaded in the random-access memory (RAM) 603 from the storage unit 608. In RAM 603, various programs and data needed for the operation of the electronic device 600 may also be stored. The computation unit 601, the ROM 602, and the RAM 603 are connected to each other through a bus 604. An input/output (I/O) interface 605 is also connected to bus 604.

A plurality of components in the electronic device 600 are connected to the I/O interface 605, including an input unit 606, e.g., a keyboard, a mouse, etc., an output unit 607, such as various types of displays, speakers, etc., a storage unit 608, such as a magnetic disk, an optical disk, etc., and a communication unit 609, such as a network card, a modem, a wireless communication transceiver, etc. The communication unit 609 may be configured to allow the electronic device 600 to exchange information/data with other devices through a computer network such as the Internet and/or various telecommunication networks.

The computation unit 601 may include various general-purpose and/or special-purpose processing assemblies with processing and computation capabilities. Some examples of the computation units 601 may include but are not limited to, a central processing unit (CPU), a graphics processing unit (GPU), various specialized artificial intelligence (AI) computing chips, various computation units that run the machine learning model algorithms, digital signal processing processor (DSP), and any suitable processor, controller, microcontroller, etc. The computation unit 601 may be configured to execute the various methods and processes described above, such as the destination recommendation method. For example, in some embodiments, the destination recommendation method may be implemented as a computer software program, which is tangibly included in a machine-readable medium, e.g., the storage unit 608. In some embodiments, a part or all of the computer program may be loaded and/or installed on the electronic device 600 via the ROM 602 and/or the communication unit 609. When the computer program is loaded into RAM 603 and executed by the computation unit 601, one or more steps of the destination recommendation method described above may be performed. In some other embodiments, the computation unit 601 may be configured to perform the destination recommendation method in any other suitable manner (e.g., firmware).

Various implementations of the systems and techniques described in the specification above may be implemented in digital electronic circuitry, an integrated circuit system, a field programmable gate array (FPGA), an application-specific integrated circuit (ASIC), an application-specific standard product (ASSP), a system on chips (SOC), a complex programmable logic device (CPLD), computer hardware, firmware, software, and/or a combination thereof. The various embodiments may be implemented in one or more computer programs. The one or more computer programs may be executed and/or explained on a programmable system including at least one programmable processor. The programmable processor may include a special purpose or general-purpose programmable processor and may receive data and instructions from a storage system, at least one input device, and at least one output device, and transmit the data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer, or another programmable data processing device. Thus, when the program codes are executed by the processor or the controller, the defined functions/operations in the flowchart and/or the block diagram may be implemented. The program codes may be entirely executed on the machine or partially executed on the machine. The program codes may be used as an individual software package to be partially executed on the machine and partially executed on a remote machine or entirely executed on the remote machine or the server.

In the context of the present disclosure, the machine-readable medium may be a tangible medium that may contain or store a program used by or used in connection with the instruction execution system, device, or apparatus. The machine-readable medium can be a machine-readable signal medium or a machine-readable storage medium. The machine-readable medium may include, but are not limited to, electronic, magnetic, optical, electromagnetic, infrared, or semiconductor system, device, apparatus, or any suitable combination thereof. More specific examples of the machine-readable storage medium may include one or more wire-based electrical connections, a portable computer disk, a hard disk, random access memory (RAM), read-only memory (ROM), erasable programmable read-only memory (EPROM or flash memory), fiber optics, compact disk read-only memory (CD-ROM), an optical storage device, a magnetic storage device, or any suitable combination thereof.

To provide interactions with a user, the systems and techniques described here may be implemented on a computer. The computer may include a display device, such as a CRT (cathode ray tube) or LCD (liquid crystal display) monitor, configured to display information to the user and a keyboard and a pointing device (e.g., a mouse or trackball). The user may provide the input to the computer through the keyboard and the pointing device. Another type of device may also be used to provide interaction with the user, for example, the feedback provided to the user may be any form of sensory feedback (e.g., visual feedback, auditory feedback, or tactile feedback). The input may be received from the user in any form (e.g., acoustic input, voice input, or tactile input).

The systems and techniques described here can be implemented on a computation system that includes a back-end component (e.g., as a data server), or a computation system that includes a middleware component (e.g., an application server), or a computation system that includes a front-end component (e.g., a user computer having a graphical user interface or web browser, the user may interact with the implementation of the system and techniques described here through the graphical user interface or the web browser), or any combination of the computer system including such the back-end components, the middleware components, or the front-end components. The components of the system may be connected to each other through the digital data communication (e.g., a communication network) through any form or medium. The communication network may include, for example, a local area network (LAN), a wide area network (WAN), and the Internet.

The computer system may include a client terminal and a server. The client terminal and the server may be generally away from each other and usually interact through the communication network. The relationship between the client terminal and the server may be generated by executing the computer program having the client terminal-server relationship on the corresponding computer.

The above description is merely embodiments of the present disclosure and description of the applied technical principle. Those skilled in the art should understand that the scope of the present disclosure is not limited to the technical solutions formed by the specific combination of the above-mentioned technical features, and should also cover, without departing from the technical concept, the above-mentioned technical features or other technical solutions formed by any combination of equivalent features of the technical features. For example, a technical solution may be formed by replacing the above features with the technical features of the present disclosure (but not limited to) with similar functions.

What is claimed is:

1. A destination recommendation method comprising:
obtaining biometric identification information of a passenger in a vehicle; and
recommending a destination for the passenger according to the biometric identification information of the passenger and a correspondence between the passenger and the destination.

2. The method according to claim 1, wherein the biometric identification information is determined according to any combination of face image information, fingerprint information, and voiceprint information.

3. The method according to claim 1, wherein recommending the destination for the passenger includes:
in response to a number of passengers being greater than 1, obtaining combined information according to biometric identification information of the passengers;
according to the correspondence between the passenger and the destination, using the destination matching the combined information as a candidate destination; and
recommending the destination for the passenger according to the candidate destination.

4. The method according to claim 3, wherein obtaining the combined information according to the biometric identification information of the passenger includes:
according to the biological identification information of the passengers and the correspondence between the biological identification information and numbering information of the passengers, obtaining the numbering information of the passengers; and
combining the numbering information of the passengers to obtain the combined information.

5. The method according to claim 4, wherein the travel information includes a number of trips and/or travel time.

6. The method according to claim 5,
wherein the travel information includes the number of trips,
the method further comprising:
performing sorting on the candidate destinations to obtain a sorting result according to the number of trips of the candidate destinations;
wherein selecting the predetermined number of the candidate destinations as the to-be-recommended destinations according to the travel information of the candidate destinations includes:
selecting the predetermined number of the candidate destinations according to the sorting result obtained based on the number of trips of the candidate destinations, a number of trips of the selected candidate destinations being greater than or equal to a number of trips of unselected candidate destinations; and
using the selected candidate destinations as the to-be-commended destinations.

7. The method according to claim 6, wherein:
the travel information further includes the travel time,
performing the sorting on the candidate destinations to obtain the sorting result according to the travel time of the candidate destinations includes:
in a process of performing the sorting on the candidate destinations according to the number of trips of the candidate destinations, in response to the number of trips of a plurality of candidate destinations being the same, performing the sorting on the plurality of candidate destinations to obtain the sorting result according to the number of trips of the plurality of candidate destinations.

8. The method according to claim 6, wherein recommending the to-be-recommended destination includes:
in response to a number of the to-be-recommended destinations being greater than 1, recommending the to-be-recommended destinations in sequence according to the sorting result.

9. The method of claim 3, further comprising:
obtaining boarding time of the passenger;
wherein recommending the destination for the passenger according to the candidate destinations includes:
in response to a number of the candidate destinations being greater than a predetermined number, selecting the predetermined number of candidate destinations as to-be-recommended destinations according to the travel time of the candidate destinations and the boarding time of the passenger; and
recommending the to-be-recommended destinations.

10. The method according to claim 3, wherein obtaining the combined information according to the biometric identification information of the passenger includes:
according to the biometric identification information of the passengers and the correspondence between the biometric identification information and the numbering information of the passenger, obtaining the numbering information of the passengers; and
combining the numbering information of the passengers to obtain the combined information.

11. The method of claim 1, further comprising:
obtaining travel time attribute information of the passenger;
wherein recommending the destination for the passenger includes:
matching the biometric identification information of the passenger and the travel time attribute information of the passenger with the correspondence of the passenger, the destination, and the travel time attribute information;
determining a candidate destination based on a matching result; and
recommending the destination for the passenger according to the candidate destination.

12. The method according to claim 11, further comprising:
obtaining a boarding location of the passenger;
wherein determining the candidate destination according to the matching result includes:
in response to the matching result indicating that matching fails, determining the candidate destination according to the boarding location of the passenger and correspondence between the boarding location and the destination.

13. The method according to claim 1, further comprising:
in response to determining that the vehicle is started, obtaining a first in-vehicle image of the vehicle;
in response to a speed of the vehicle being smaller than a predetermined speed, obtaining a second in-vehicle image of the vehicle;
determining a passenger who gets off the vehicle according to the first in-vehicle image and the second in-vehicle image;
determining the destination of the passenger who got off the vehicle according to current location information; and
recording the biometric identification information of the passenger who gets off the vehicle and the destination of the passenger who gets off the vehicle to update the correspondence between the passenger and the destination.

14. The method according to claim 13, further comprising:
in response to determining that the vehicle is started, obtaining boarding time of the passenger in the first in-vehicle image; and
determining travel time attribute information of the destination of the passenger who gets off the vehicle according to the boarding time of the passenger;
wherein recording of the biometric identification information of the passenger who gets off the vehicle and the destination of the passenger who gets off the vehicle to obtain the correspondence between the passenger and the destination includes:
recording the biometric identification information of the passenger who gets off the vehicle, the destination of the passenger who gets off the vehicle, and the travel time attribute information of the destination of the passenger who gets off the vehicle to update the correspondence among the passenger, the destination, and the travel time attribute information.

15. The method according to claim 14, wherein determining the travel time attribute information of the destination of the passenger who gets off the vehicle according to the boarding time of the passenger includes:
for the destination of the passenger who gets off the bus, obtaining the travel time of the destination of the passenger who gets off the bus according to all boarding times corresponding to the destination of the passenger; and
according to the travel time of the destination of the passenger who gets off the vehicle, determining the travel time attribute information of the destination of the passenger who gets off the vehicle.

16. An electronic device comprising:
a processor; and
a memory communicatively coupled to the processor and storing an instruction that, when executed by the processor, causes the processor to:
obtain biometric identification information of a passenger in a vehicle; and
recommend a destination for the passenger according to the biometric identification information of the passenger and a correspondence between the passenger and the destination.

17. A non-transitory computer-readable storage medium storing a computer program that, when executed by a processor, causes the processor to:
obtain biometric identification information of a passenger in a vehicle; and
recommend a destination for the passenger according to the biometric identification information of the passenger and a correspondence between the passenger and the destination.

18. The storage medium according to claim 17, wherein the biometric identification information is determined according to any combination of face image information, fingerprint information, and voiceprint information.

19. The storage medium according to claim 17, wherein the processor is further configured to:
in response to a number of passengers being greater than 1, obtain combined information according to biometric identification information of the passengers;
according to the correspondence between the passenger and the destination, use the destination matching the combined information as a candidate destination; and
recommend the destination for the passenger according to the candidate destination.

20. The storage medium according to claim 19, wherein the processor is further configured to:
according to the biological identification information of the passengers and the correspondence between the biological identification information and numbering information of the passengers, obtain the numbering information of the passengers; and
combine the numbering information of the passengers to obtain the combined information.
